(19) United States
(12) Patent Application Publication
(10) Pub. No.: US 2018/0077257 A1
(43) Pub. Date: Mar. 15, 2018

(54) CACHING CONTENT AT THE EDGE

(71) Applicants: Jun WANG, San Diego, CA (US); Xipeng ZHU, San Diego, CA (US); Xiaoxia ZHANG, San Diego, CA (US); Carlos Marcelo Dias PAZOS, San Diego, CA (US); Ozean OZTURK, San Diego, CA (US); QUALCOMM Incorporated, San Diego, CA (US)

(72) Inventors: Jun WANG, Poway, CA (US); Xipeng ZHU, Beijing (CN); Xiaoxia ZHANG, San Diego, CA (US); Carlos Marcelo Dias PAZOS, Carlsbad, CA (US); Ozcan OZTURK, San Diego, CA (US)

(21) Appl. No.: 15/564,663

(22) PCT Filed: Apr. 22, 2015
(86) PCT No.: PCT/CN2015/077185

§ 371 Date: Oct. 5, 2017

(51) Int. Cl. H04L 29/08; H04W 28/14

(52) U.S. Cl. CPC H04L 67/2842; H04L 67/1014; H04W 28/14; H04L 67/288

(57) ABSTRACT

Certain aspects of the present disclosure provide methods and apparatus for caching content at a network edge and providing the cached content to requesting UEs. An example method generally includes receiving, from a first UE, a request for content from a remote source, retrieving the content from the remote source and providing the content to the first UE, storing at least a portion of the content in a local cache at the base station, receiving a request for the content from at least a second UE, and retrieving the content from the local cache and providing the content to the at least the second UE.

### TECHNICAL FIELD

Certain embodiments of the present disclosure generally relate to caching content at network edges.

### BACKGROUND

Wireless communication systems are widely deployed to provide various types of communication content such as voice, data, and so on. These systems may be multiple-access systems capable of supporting communication with multiple users by sharing the available system resources (e.g., bandwidth and transmit power). Examples of such multiple-access systems include code division multiple access (CDMA) systems, time division multiple access (TDMA) systems, frequency division multiple access (FDMA) systems, 3GPP Long Term Evolution (LTE) systems, and orthogonal frequency division multiple access (OFDMA) systems.

Generally, a wireless multiple-access communication system can simultaneously support communication for multiple wireless terminals. Each terminal communicates with one or more base stations via transmissions on the forward and reverse links. The forward link (or downlink) refers to the communication link from the base stations to the terminals, and the reverse link (or uplink) refers to the communication link from the terminals to the base stations. This communication link may be established via a single-in-single-out, multiple-in-single-out or a multiple-in-multiple-out (MIMO) system.

Wireless devices comprise user equipments (UEs) and remote devices. A UE is a device that operates under direct control by humans. Some examples of UEs include cellular phones (e.g., smart phones), personal digital assistants (PDAs), wireless modems, handheld devices, laptop computers, tablets, netbooks, smartbooks, ultrabooks, robots, drones, wearable devices (e.g., smart watch, smart bracelet, smart clothing, smart glasses), etc. A remote device is a device that operates without being directly controlled by humans. Some examples of remote devices include autonomous robots, autonomous drones, sensors, meters, location tags, monitoring devices, etc. A remote device may communicate with a base station, another remote device, or some other entity. Machine type communication (MTC) refers to communication involving at least one remote device on at least one end of the communication.

### SUMMARY

Certain aspects of the present disclosure provide a method for communicating by a base station. The method generally includes receiving, from a first user equipment (UE), a request for content from a remote source; retrieving the content from the remote source and providing the content to the first UE; storing at least a portion of the content in a local cache at the base station; receiving a request for the content from at least a second UE; and retrieving the content from the local cache and providing the content to the second UE.

Certain aspects of the present disclosure also include various apparatuses and computer program products capable of performing the operations described above.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout and wherein:

FIG. 1 illustrates a multiple access wireless communication system, according to aspects of the present disclosure.

FIG. 2 is a block diagram of a communication system, according to aspects of the present disclosure.

FIG. 3 illustrates an example frame structure, according to aspects of the present disclosure.

FIG. 4 illustrates an example subframe resource element mapping, according to aspects of the present disclosure.

FIG. 5 illustrates example operations that may be performed by a base station to cache content for transmission to a plurality of user equipments (UEs), in accordance with an aspect of the present disclosure.

FIG. 6 illustrates an example network architecture with caching performed at a plurality of eNodeBs, in accordance with an aspect of the present disclosure.

FIG. 7 illustrates an example of synchronization between base stations, in accordance with an aspect of the present disclosure.

FIG. 8 illustrates an example flow diagram of operations for caching content at a network edge and transmitting cached content to a UE, in accordance with an aspect of the present disclosure.

FIG. 9 illustrates an example flow diagram of operations for caching content at a network edge and transmitting cached content to a UE, in accordance with an aspect of the present disclosure.

FIG. 10 illustrates an example flow diagram of operations for caching content and transmitting cached content to a UE, in accordance with an aspect of the present disclosure.

### DETAILED DESCRIPTION

Aspects of the present disclosure provide techniques for caching content at a network edge. Caching content at a network edge may allow for reduced latency in the provisioning of content to requesting UEs.

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

The techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), cdma2000, etc. UTRA includes Wideband-CDMA (W-CDMA) and Low Chip Rate (LCR), cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). Long Term Evolution (LTE) is an upcoming release of UMTS that uses E-UTRA. UTRA, E-UTRA, GSM, UMTS and LTE are described in documents from an organization named “3rd Generation Partnership Project” (3GPP), cdma2000 is described in documents from an organization named “3rd Generation Partnership Project 2” (3GPP2). These various radio technologies and standards are known in the art. For clarity, certain aspects of the techniques are described below for LTE, and LTE terminology is used in much of the description below.

Single carrier frequency division multiple access (SC-FDMA), which utilizes single carrier modulation and frequency domain equalization is a technique. SC-FDMA has similar performance and essentially the same overall complexity as those of OFDMA system. SC-FDMA signal has lower peak-to-average power ratio (PAPR) because of its inherent single carrier structure. SC-FDMA has drawn great attention, especially in the uplink communications where lower PAPR greatly benefits the mobile terminal in terms of transmit power efficiency. It is currently a working assumption for uplink multiple access scheme in 3GPP Long Term Evolution (LTE), or Evolved UTRA.

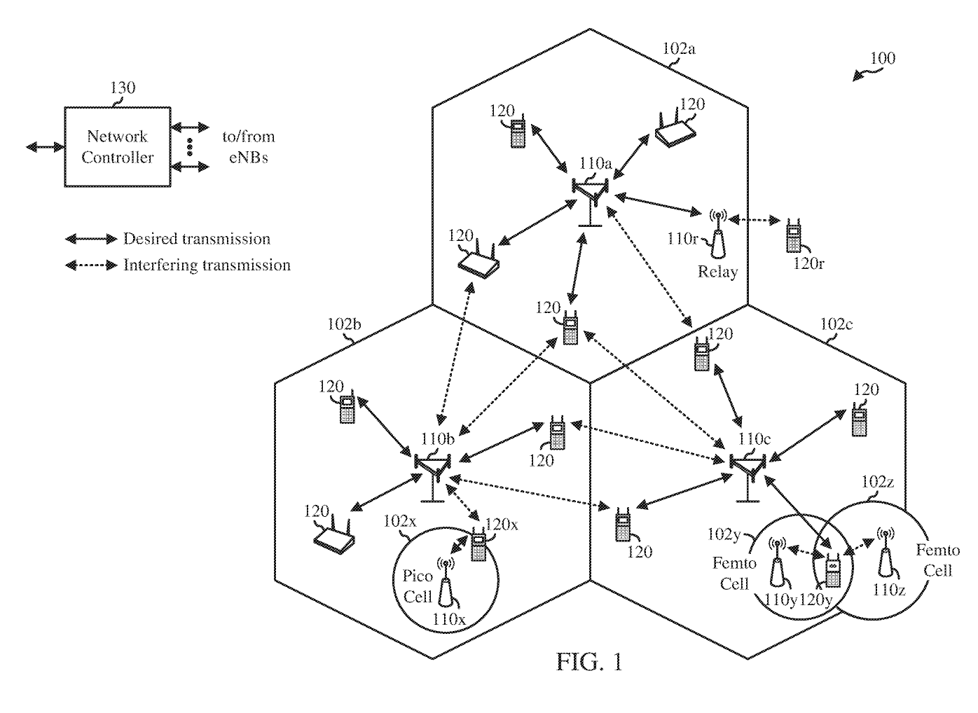

FIG. 1 shows a wireless communication network 100 in which aspects of the present disclosure may be practiced. For example, evolved Node Bs 110 may cache content and transmit the cached content to user equipments (UEs) 120 as described herein.

Wireless communication network 100 may be an LTE network. The wireless network 100 may include a number of evolved Node Bs (eNBs) 110 and other network entities. An eNB may be a station that communicates with the UEs and may also be referred to as a base station, an access point, etc. A Node B is another example of a station that communicates with the UEs.

Each eNB 110 may provide communication coverage for a particular geographic area. In 3GPP, the term “cell” can refer to a coverage area of an eNB and/or an eNB subsystem serving this coverage area, depending on the context in which the term is used.

An eNB may provide communication coverage for a macro cell, a pico cell, a femto cell, and/or other types of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a Closed Subscriber Group (CSG), UEs for users in the home, etc.). An eNB for a macro cell may be referred to as a macro eNB. An eNB for a pico cell may be referred to as a pico eNB. An eNB for a femto cell may be referred to as a femto eNB or a home eNB. In the example shown in FIG. 1, the eNBs 110a, 110b and 110c may be macro eNBs for the macro cells 102a, 102b and 102c, respectively. The eNB 110x may be a pico eNB for a pico cell 102x, The eNBs 110y and 110z may be femto eNBs for the femto cells 102y and 102z, respectively. An eNB may support one or multiple (e.g., three) cells.

The wireless network 100 may also include relay stations. A relay station is a station that receives a transmission of data and/or other information from an upstream station (e.g., an eNB or a UE) and sends a transmission of the data and/or other information to a downstream station (e.g., a UE or an eNB). A relay station may also be a UE that relays transmissions for other UEs. In the example shown in FIG. 1, a relay station 110r may communicate with the eNB 110a and a UE 120r in order to facilitate communication between the eNB 110a and the UE 120r. A relay station may also be referred to as a relay eNB, a relay, etc.

The wireless network 100 may be a heterogeneous network that includes eNBs of different types, e.g., macro eNBs, pico eNBs, femto eNBs, relays, etc. These different types of eNBs may have different transmit power levels, different coverage areas, and different impact on interference in the wireless network 100. For example, macro eNBs may have a high transmit power level (e.g., 20 Watts) whereas pico eNBs, femto eNBs and relays may have a lower transmit power level (e.g., 1 Watt).

The wireless network 100 may support synchronous or asynchronous operation. For synchronous operation, the eNBs may have similar frame timing, and transmissions from different eNBs may be approximately aligned in time. For asynchronous operation, the eNBs may have different frame timing, and transmissions from different eNBs may not be aligned in time. The techniques described herein may be used for both synchronous and asynchronous operation.

A network controller 130 may couple to a set of eNBs and provide coordination and control for these eNBs. The network controller 130 may communicate with the eNBs 110 via a backhaul. The eNBs 110 may also communicate with one another, e.g., directly or indirectly via wireless or wireline backhaul.

The UEs 120 may be dispersed throughout the wireless network 100, and each UE may be stationary or mobile. A UE may also be referred to as a terminal, a mobile station, a subscriber unit, a station, etc. A UE may be a cellular phone, a personal digital assistant (PDA), a wireless modem, a wireless communication device, a handheld device, a laptop computer, a cordless phone, a wireless local loop (WLL) station, etc. A UE may be able to communicate with macro eNBs, pico eNBs, femto eNBs, relays, etc. In FIG. 1, a solid line with double arrows indicates desired transmissions between a UE and a serving eNB, which is an eNB designated to serve the UE on the downlink and/or uplink. A dashed line with double arrows indicates interfering transmissions between a UE and an eNB.

LTE utilizes orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a ‘resource block’) may be 12 subcarriers (or 180 kHz). Consequently, the nominal FFT size may be equal to 128, 256, 512, 1024 or 2048 for system bandwidth of 1.25, 2.5, 5, 10 or 20 megahertz (MHz), respectively. The system bandwidth may also be partitioned into subbands. For example, a subband may cover 1.08 MHz (i.e., 6 resource blocks), and there may be 1, 2, 4, 8 or 16 subbands for system bandwidth of 1.25, 2.5, 5, 10 or 20 MHz, respectively.

The wireless network 100 may also include UEs 120 capable of communicating with a core network via one or more radio access networks (RANs) that implement one or more radio access technologies (RATs). For example, according to certain aspects provided herein, the wireless network 100 may include co-located access points (APs) and/or base stations that provide communication through a first RAN implementing a first RAT and a second RAN implementing a second RAT. According to certain aspects, the first RAN may be a wide area wireless access network (WWAN) and the second RAN may be a wireless local area network (WLAN). Examples of WWAN may include, but not be limited to, for example, radio access technologies (RATs) such as LTE, UMTS, cdma2000, GSM, and the like. Examples of WLAN may include, but not be limited to, for example, RATs such as Wi-Fi or IEEE 802.11 based technologies, and the like.

According to certain aspects provided herein, the wireless network 100 may include co-located Wi-Fi access points (APs) and femto eNBs that provide communication through Wi-Fi and cellular radio links. As used herein, the term “co-located” generally means “in close proximity to,” and applies to Wi-Fi APs or femto eNBs within the same device enclosure or within separate devices that are in close proximity to each other. According to certain aspects of the present disclosure, as used herein, the term “femtoAP” may refer to a co-located Wi-Fi AP and femto eNB.

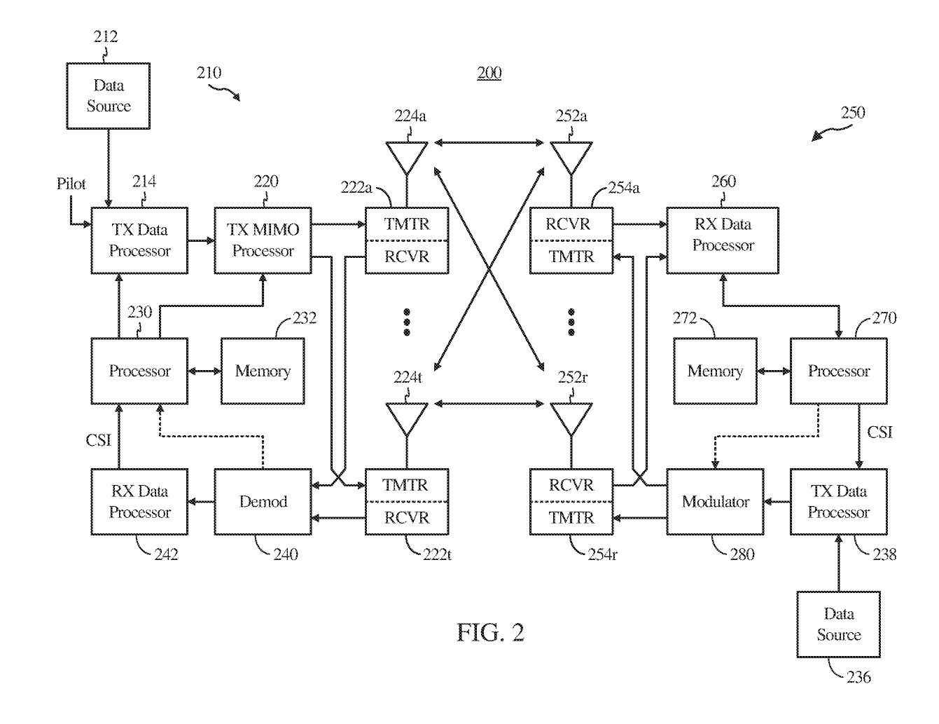

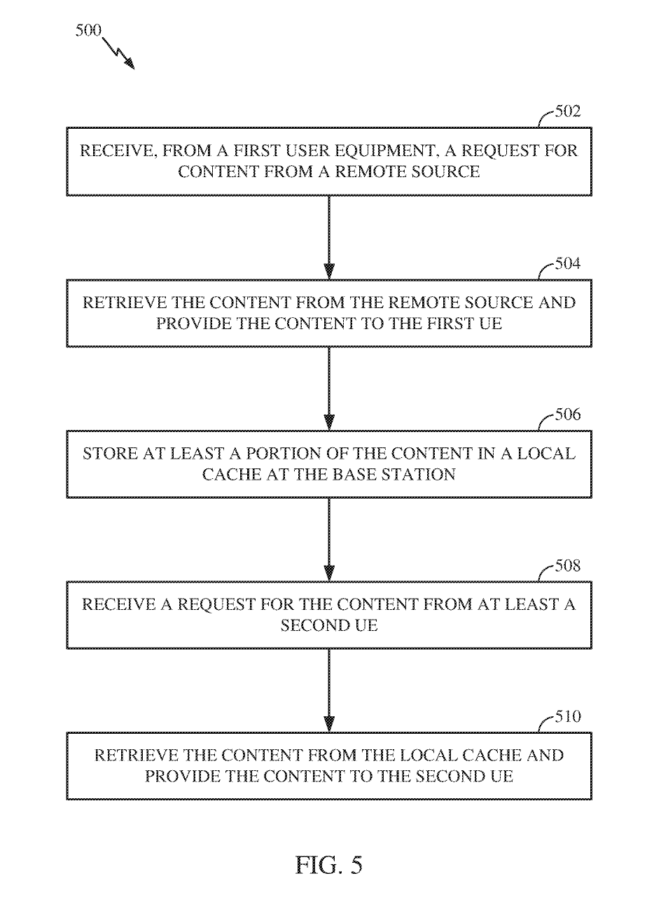

FIG. 2 is a block diagram of an embodiment of a transmitter system 210 (also known as an access point (AP)) and a receiver system 250 (also known as a user equipment (UE)) in a system, such as a MIMO system 200. Aspects of the present disclosure may practiced in the transmitter system (AP) 210 and the receiver system (UE) 250. Although referred to as transmitter system 210 and receiver system 250, these systems can transmit as well as receive, depending on the application. For example, transmitter system 210 may be configured to cache data requested by a receiver system 250 and provide the data to other receiver systems from the cache, as described below with reference to FIG. 5.

At the transmitter system 210, traffic data for a number of data streams is provided from a data source 212 to a transmit (TX) data processor 214. In an aspect, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r, and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use. Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights and then processes the extracted message.

According to certain aspects, the controllers/processors 230 and 270 may direct the operation at the transmitter system 210 and the receiver system 250, respectively. According to an aspect, the processor 230, TX data processor 214, and/or other processors and modules at the transmitter system 210 may perform or direct processes for the techniques described herein. According to another aspect, the processor 270, RX data processor 260, and/or other processors and modules at the receiver system 250 may perform or direct processes for the techniques described herein. For example, the processor 230, TX data processor 214, and/or other processors and modules at the transmitter system 210 may perform or direct operations 500 in FIG. 5. For example, the processor 270, RX data processor 260, and/or other processors and modules at the receiver system 250 may perform or direct operations at receiver system 250.

In an aspect, logical channels are classified into Control Channels and Traffic Channels. Logical Control Channels comprise Broadcast Control Channel (BCCH), which is a DL channel for broadcasting system control information. Paging Control Channel (PCCH) is a DL channel that transfers paging information. Multicast Control Channel (MCCH) is a point-to-multipoint DL channel used for transmitting Multimedia Broadcast and Multicast Service (MBMS) scheduling and control information for one or several MTCHs. Generally, after establishing an RRC connection, this channel is only used by UEs that receive MBMS (Note: old MCCH+MSCH). Dedicated Control Channel (DCCH) is a point-to-point bi-directional channel that transmits dedicated control information used by UEs having an RRC connection. In an aspect, Logical Traffic Channels comprise a Dedicated Traffic Channel (DTCH), which is a point-to-point bi-directional channel, dedicated to one UE, for the transfer of user information. Also, a Multicast Traffic Channel (MTCH) is a point-to-multipoint DL channel for transmitting traffic data.

In an aspect, Transport Channels are classified into DL and UL. DL Transport Channels comprise a Broadcast Channel (BCH), Downlink Shared Data Channel (DL-SDCH), and a Paging Channel (PCH), the PCH for support of UE power saving (DRX cycle is indicated by the network to the UE), broadcasted over entire cell and mapped to PHY resources which can be used for other control/traffic channels. The UL Transport Channels comprise a Random Access Channel (RACH), a Request Channel (REQCH), an Uplink Shared Data Channel (UL-SDCH), and a plurality of PHY channels. The PHY channels comprise a set of DL channels and UL channels.

In an aspect, a channel structure is provided that preserves low PAPR (at any given time, the channel is contiguous or uniformly spaced in frequency) properties of a single carrier waveform.

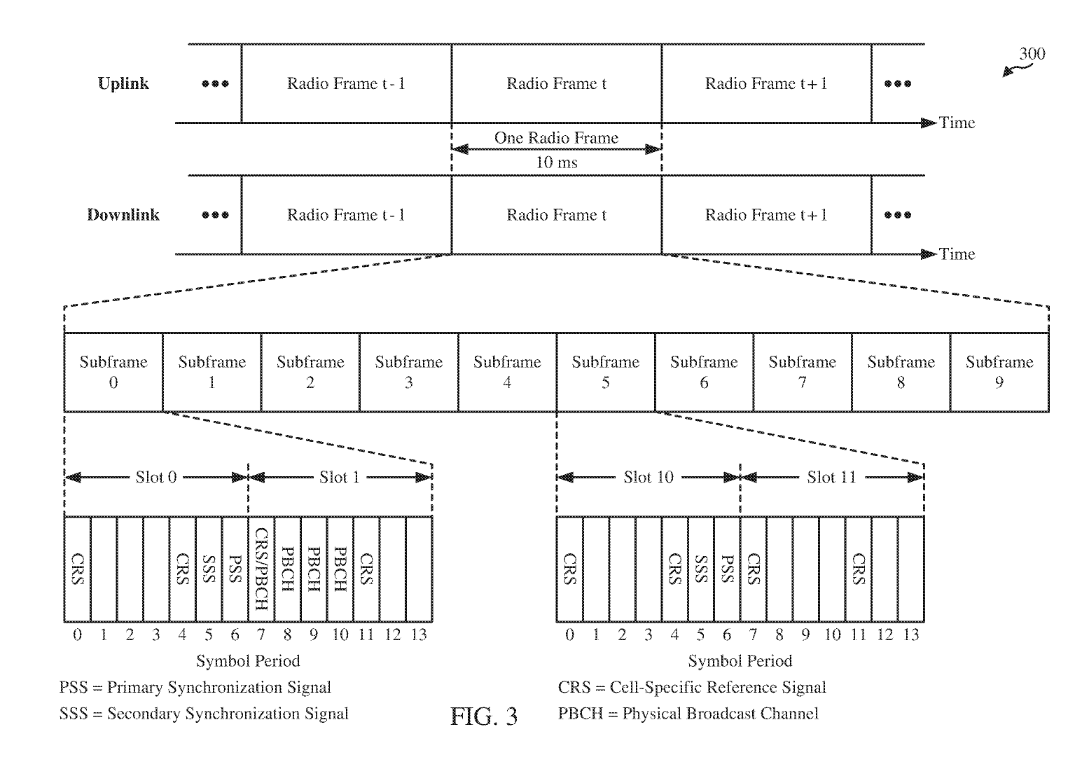

FIG. 3 shows an exemplary frame structure 300 for FDD in LTE. The transmission timeline for each of the downlink and uplink may be partitioned into units of radio frames. Each radio frame may have a predetermined duration (e.g., 10 milliseconds (ms)) and may be partitioned into 10 subframes with indices of 0 through 9. Each subframe may include two slots. Each radio frame may thus include 20 slots with indices of 0 through 19. Each slot may include L symbol periods, e.g., seven symbol periods for a normal cyclic prefix (as shown in FIG. 2) or six symbol periods for an extended cyclic prefix. The 2L symbol periods in each subframe may be assigned indices of 0 through 2L−1.

In LTE, an eNB may transmit a primary synchronization signal (PSS) and a secondary synchronization signal (SSS) on the downlink in the center 1.08 MHz of the system bandwidth for each cell supported by the eNB. The PSS and SSS may be transmitted in symbol periods 6 and 5, respectively, in subframes 0 and 5 of each radio frame with the normal cyclic prefix, as shown in FIG. 3. The PSS and SSS may be used by UEs for cell search and acquisition. During cell search and acquisition the terminal detects the cell frame timing and the physical-layer identity of the cell from which the terminal learns the start of the references-signal sequence (given by the frame timing) and the reference-signal sequence of the cell (given by the physical layer cell identity). The eNB may transmit a cell-specific reference signal (CRS) across the system bandwidth for each cell supported by the eNB. The CRS may be transmitted in certain symbol periods of each subframe and may be used by the UEs to perform channel estimation, channel quality measurement, and/or other functions. In aspects, different and/or additional reference signals may be employed. The eNB may also transmit a Physical Broadcast Channel (PBCH) in symbol periods 0 to 3 in slot 1 of certain radio frames. The PBCH may carry some system information. The eNB may transmit other system information such as System Information Blocks (SIBs) on a Physical Downlink Shared Channel (PDSCH) in certain subframes. The eNB may transmit control information/data on a Physical Downlink Control Channel (PDCCH) in the first B symbol periods of a subframe, where B may be configurable for each subframe. The eNB may transmit traffic data and/or other data on the PDSCH in the remaining symbol periods of each subframe.

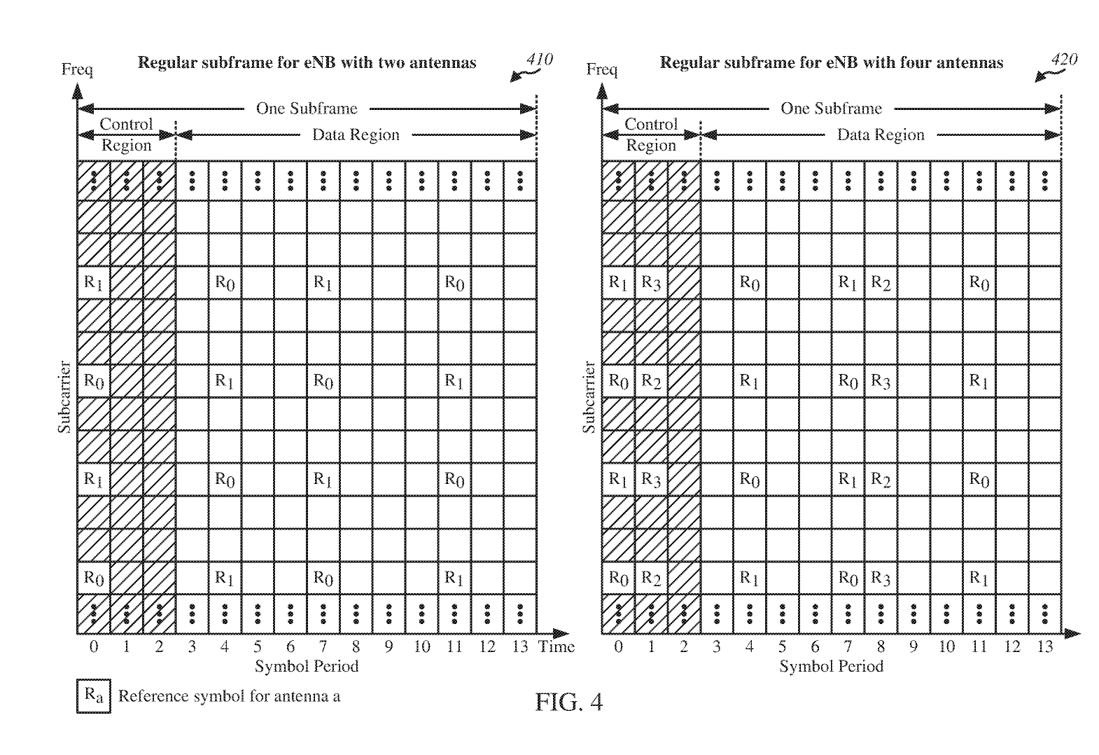

FIG. 4 shows two exemplary subframe formats 410 and 420 for the downlink with the normal cyclic prefix. The available time frequency resources for the downlink may be partitioned into resource blocks. Each resource block may cover 12 subcarriers in one slot and may include a number of resource elements. Each resource element may cover one subcarrier in one symbol period and may be used to send one modulation symbol, which may be a real or complex value.

Subframe format 410 may be used for an eNB equipped with two antennas. A CRS may be transmitted from antennas 0 and 1 in symbol periods 0, 4, 7 and 11. A reference signal is a signal that is known a priori by a transmitter and a receiver and may also be referred to as a pilot. A CRS is a reference signal that is specific for a cell, e.g., generated based on a cell identity (ID). In FIG. 4, for a given resource element with label Rₐ, a modulation symbol may be transmitted on that resource element from antenna a, and no modulation symbols may be transmitted on that resource element from other antennas. Subframe format 420 may be used for an eNB equipped with four antennas. A CRS may be transmitted from antennas 0 and 1 in symbol periods 0, 4, 7 and 11 and from antennas 2 and 3 in symbol periods 1 and 8. For both subframe formats 410 and 420, a CRS may be transmitted on evenly spaced subcarriers, which may be determined based on cell ID. Different eNBs may transmit their CRSs on the same or different subcarriers, depending on their cell IDs. For both subframe formats 410 and 420, resource elements not used for the CRS may be used to transmit data (e.g., traffic data, control data, and/or other data).

The PSS, SSS. CRS and PBCH in LTE are described in 3GPP TS 36.211, entitled “Evolved Universal Terrestrial Radio Access (E-UTRA); Physical Channels and Modulation,” which is publicly available.

An interlace structure may be used for each of the downlink and uplink for FDD in LTE. For example, Q interlaces with indices of 0 through Q−1 may be defined, where Q may be equal to 4, 6, 8, 10, or some other value. Each interlace may include subframes that are spaced apart by Q frames. In particular, interlace q may include subframes q, q+Q, q+2Q, etc., where qε{0, . . . , Q−1}.

The wireless network may support hybrid automatic retransmission (HARQ) for data transmission on the downlink and uplink. For HARQ, a transmitter (e.g., an eNB) may send one or more transmissions of a packet until the packet is decoded correctly by a receiver (e.g., a UE) or some other termination condition is encountered. For synchronous HARQ, all transmissions of the packet may be sent in subframes of a single interlace. For asynchronous HARQ, each transmission of the packet may be sent in any subframe.

A UE may be located within the coverage area of multiple eNBs. One of these eNBs may be selected to serve the UE. The serving eNB may be selected based on various criteria such as received signal strength, received signal quality, pathloss, etc. Received signal quality may be quantified by a signal-to-noise-and-interference ratio (SINR), or a reference signal received quality (RSRQ), or some other metric. The UE may operate in a dominant interference scenario in which the UE may observe high interference from one or more interfering eNBs.

### Caching Content at Network Edges

Certain aspects of the present disclosure provide mechanisms for caching requested content at a network edge. Caching content at network edges may allow for reduced latency in provisioning content to a plurality of UEs requesting the same content.

Caching content generally allows for reduced latency in delivery of content. Reductions in latency may be useful in a variety of scenarios, such as industrial automation, delivery of content in real-time applications (e.g., online video games), to provide for increased TCP throughput, and so on. Caching at a network edge may reduce an amount of backhaul transmissions and reduce processing delays in provisioning the same content to a plurality of UEs. Requested data may be served, thus, from a device on the network edge rather than from a remote source, which may reduce the amount of traffic on a core network.

FIG. 5 illustrates example operations 500 that may be performed to cache content at a network edge and provide the content to a plurality of UEs from the cache, according to an aspect of the present disclosure.

Operations 500 begin at 502, where a base station receives, from a first user equipment (UE), a request for content from a remote source. At 504, the base station retrieves the content from the remote source and provides the content to the first UE. At 506, the base station stores at least a portion of the content in a local cache at the base station. At 508, the base station receives a request for the content from at least a second UE. At 510, the base station retrieves the content from the local cache and provides the content to the second UE.

In an aspect, content may be cached at a local gateway. For example, the content may be cached in a local gateway (LGW) collocated with the eNB or a standalone LGW. If a LGW is not supported by the network, the content may be cached in a Packet Data Network (PDN) gateway (P-GW). In a network using a broadcast-multicast architecture, content may be cached at a broadcast/multicast service center (BM-SC) located in a local network. Caching content at a local gateway or BM-SC may allow for a global view of content consumption; that is, an operator may be able to determine, based on content requests and the provisioning of content, what content users on the network are interested in.

In an example, the LGW, P-GW, or BM-SC may transmit a Dynamic Adaptive Streaming over HTTP (DASH) or HTTP request (e.g., an HTTP GET request) to a remote server to request content. The requested content may be pushed from the remote server to the LGW, P-GW, or BM-SC. For example, if content is requested using DASH, the remote server may transmit a plurality of DASH segments to the LGW, P-GW, or BM-SC. Similarly, in a Content Delivery Network (CDN), when a UE performs a DNS look up for content (for example www.video.example.com), the DNS look up can direct the UE to access the local server or cache located in the L-GW or P-GW. When the UE requests the content, the LGW or the P-GW may send the requested segments to the UE through the unicast channel. The BM-SC may transmit DASH segments to the UEs, e.g., via an enhanced multimedia broadcast/multicast service (eMBMS) channel. UEs may fetch missing content from the BM-SC, for example, using file repair procedures; however, instead of retrieving the missing content from a remote server, the UEs may retrieve the missing content from cached content at the local server (e.g., located in the BM-SC).

In some cases, a network may include two gateways. Each gateway may have a distinct access point name (APN). A UE may communicate through one gateway for low latency traffic and through another gateway for regular traffic. The gateway used for low latency traffic may include a local cache at which content may be cached for transmission to other UEs, as described herein. If requested content is not cached at the gateway used for low latency traffic, the eNB may request content from the remote server via the gateway used for regular traffic, which may route communications to the remote server through the core network.

In an aspect, content may be cached at an eNodeB (eNB). In this case, the eNB is served as local proxy or local server. The eNB can cache content requested by a first UE and transmit the same content to other UEs that request the same content. An eNB may determine that other UEs are requesting the same content, for example, by performing Deep Packet Inspection (DPI). In streaming applications (e.g., DASH), the eNB may act as a client to fetch content for the plurality of requesting UEs. In some cases, the eNB may predict that certain content will be requested by a UE (or a plurality of UEs) and begin to fetch and catch that content preemptively for retransmission to requesting UEs in the future.

In some cases, the eNB may act as a proxy server. Resources requested by one UE may be made available to other UEs, whether connected to the same eNB or to a neighbor eNB. In some cases, a remote server can predict that a large number of UEs may request particular content from the remote server and push the predicted content to the eNB, which then caches the content and provides the content to UEs from the cache. The eNB may receive the content from the remote server through a P-GW or directly from the remote server via an internet connection or a low latency network connection. The UE is assigned an IP address from the P-GW. When a UE moves from the eNB to a neighbor eNB, the UE's IP address need not change.

In some cases, whether the eNB acts as a proxy server may be transparent to the UE. The eNB may implement a full network protocol stack. A TCP session may be established between a UE and the eNB, and between the eNB and the remote server. The eNB performs DPI. If the eNB detects it does not have the requested content in cache, the eNB may request the data from the remote server directly through internet or CDN. Alternatively, the eNB may request content from the remote server, for example by transmitting the request through a GPRS Transport Protocol (GTP) tunnel (e.g., a GTP-User Plane (GTP-U) tunnel), or by forwarding a request for content to the packet data network gateway (P-GW) using an IP interface. The GTP-U tunnel may be per eNB instead of per UE tunnel.

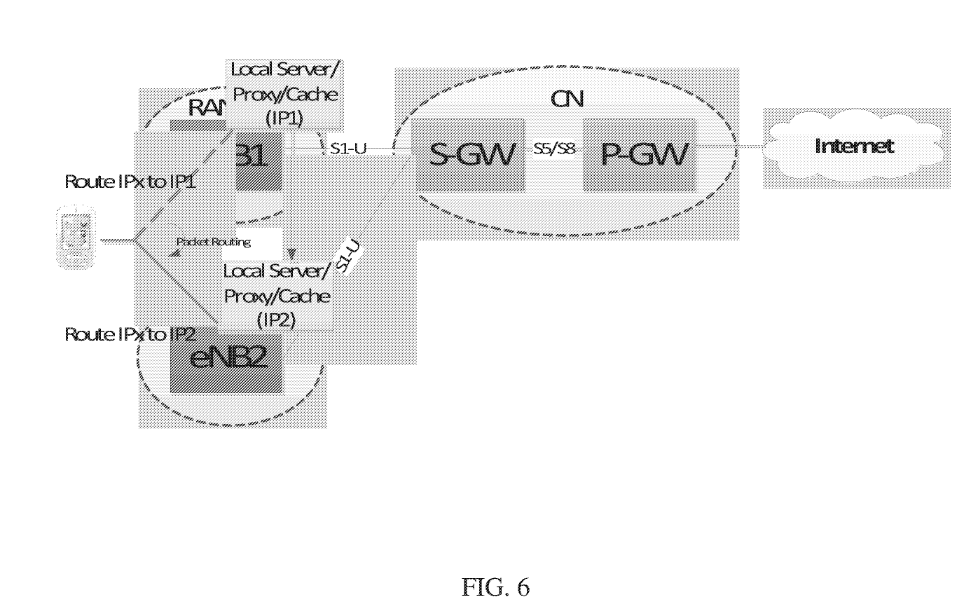

FIG. 6 illustrates an example network architecture in which multiple eNodeBs cache content, in accordance with aspects of the present disclosure. In some aspects, for UE mobility and load balancing, the same content or segments of content may be duplicated and cached in neighboring eNBs. Alternatively, different content or segments of content can be disturbed and cached in the neighboring eNBs. When the UE moves from one eNB to another eNB, the UE may continue to receive data from the previous proxy/server which is located in the source eNB over an X2 interface. In some aspects, a session with the previous proxy located in the source eNB may be discontinued, and the UE may re-establish a session (for example, TCP or UDP) between the UE and the new proxy in the target eNB. The UE may continue to retrieve the data from the previous proxy until the UE establishes the connection with the new proxy. In some aspects, HTTP redirection from the previous proxy may be used to redirect the UE to the target proxy. A TCP session may be transferred from the source proxy to the target proxy. When a TCP session transfer is triggered by an X2 context transfer, the source proxy can move a socket to the target proxy. The TCP session may be transferred from a source proxy/local server having a first IP address to a target proxy/local server having a second IP address. The transferred session may include TCP sequences and TCP segments that have not been acknowledged. Each server may have a virtual interface with an IP address (IPx). The UE may use the virtual IPx for access to a local proxy/server, and the eNB may route content to local proxy/server's IP address.

In some cases, the eNB may switch from transmitting the requested content to the requesting UEs via unicast to transmitting via broadcast or multicast (e.g., using eMBMS or Single-Cell Point to Multipoint (SC-PTM) transmission). If the eNB determines that a number of UEs requesting the same content exceeds a threshold value, which may be a configurable value, the eNB can switch to eMBMS or SC-PTM transmission for traffic uploading. If the eNB switches to SC-PTM transmission, the eNB may hand over requesting UEs or redirect requesting UEs to a shared physical downlink shared channel (PDSCH).

In some cases, the eNB may transmit data using different radio access technologies (RATs). For example, if the eNB determines that a number of UEs requesting the same content exceeds a threshold value, which may be a configurable value, the eNB can switch data transmission of cached content from one RAT to another RAT.

In some cases, an eNB can enable eMBMS transmission if content consumption is detected in neighboring eNBs. Detecting that the same content is being requested by UEs served by multiple eNBs may be performed, for example, through a protocol across eNBs (e.g., using an X2 interface or an enhanced X2 interface), or through an interface between eNBs and higher layer components (e.g., a mobility management entity (MME) or multi-cell/multicast coordination entity (MCE)).

An eNB may determine that a neighbor eNB has cached content in a variety of ways. In an aspect, the first eNB that retrieves content from a remote server may push the content to neighbor eNBs (e.g., via an X2 interface). In an aspect, the first eNB that retrieves content may inform other eNBs that the first eNB has retrieved content associated with a particular address (e.g., a particular URL). Other eNBs may retrieve the content from the first eNB when a UE served by one of the other eNBs transmits a request for content associated with the same address. In an aspect, the first eNB may announce the particular address associated with requested content to an MME. eNBs within a network may query the MME for content associated with a particular address. If the MME indicates that the first eNB has previously retrieved the content, other eNBs may request the content from the first eNB rather than the remote server. If the MME indicates that the content has not previously been retrieved by an eNB, the eNB may forward a request for the content to a remote server (and cache the content, as described above).

The eNB or MCE (e.g., an “anchor” eNB) may coordinate multicast/broadcast single frequency network operations with other eNBs by synchronizing timestamps across the eNBs. For example, the anchor eNB may set the time stamp based on the furthermost eNB. An eNB may indicate to an MCE that an MBMS session should be initiated. If the MCE is centralized, an indication that an MBMS session should be initiated may be made, for example, using an enhanced M1 interface (e.g., an eNB-MCE interface). If the MCE is co-located with an eNB, an indication that an MBMS session should be initiated may be made, for example, using an enhanced X2 interface (e.g., between eNBs), or by using an MCE-MCE interface. Once the eMBMS channel is set up, the eNB may redirect UEs requesting the content to tune to the eMBMS channel.

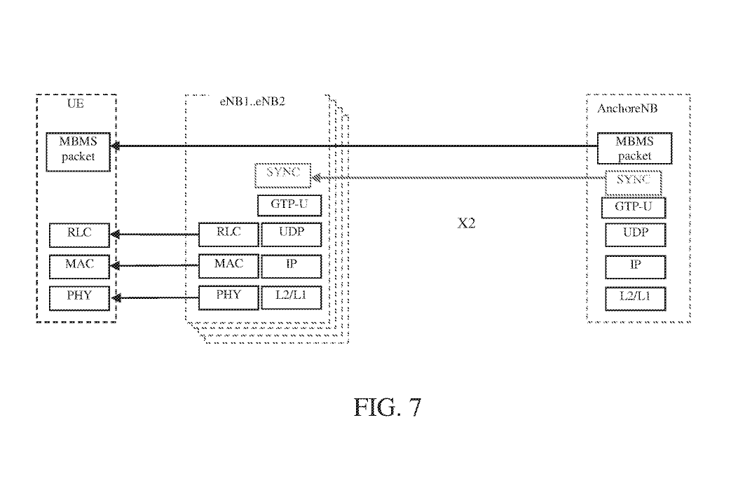

FIG. 7 illustrates synchronization among eNBs for multicast/broadcast services, according to an aspect of the present disclosure. As illustrated, an “anchor eNB” may cache content and may transmit MBMS packets (including the cached content) to the UEs (e.g., via a broadcast or multicast channel). The “anchor eNB” may synchronize with other eNBs to create a single frequency network to serve the cached data to a plurality of UEs. “SYNC” may be a protocol to synchronize data used to generate a certain radio frame. The eNBs may be part of an MBSFN.

In some cases, user services description (USD) information may be transmitted to UEs from a network edge device (e.g., an eNB or BM-SC). USD may be transmitted, for example, through dedicated signaling (e.g., via radio resource control (RRC) or network access stratum (NAS) signaling), on an SC-PTM channel, or on an eMBMS channel. In some cases, if USD is transmitted on an eMBMS channel, a separate USD channel may be implemented for communication of locally generated USD information.

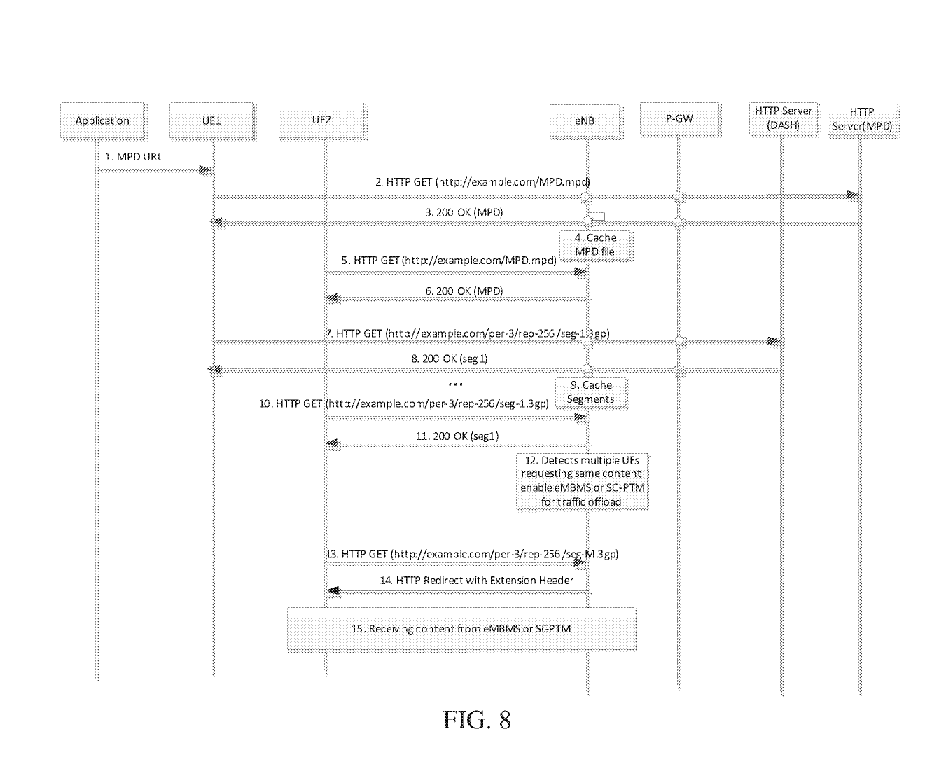

FIG. 8 illustrates an example of content caching at an eNodeB, according to aspects of the present disclosure. As illustrated, a first UE requests content from a remote server. In a streaming video example, the first UE may request a media presentation description (MPD) file that describes the requested content and provides information for a client to stream content by requesting media segments from a server. The request is transmitted from a UE through an eNodeB to an eventual endpoint of a server hosting the file.

On receiving the request for the MPD file, the remote server may transmit the MPD file to the UE through the eNodeB, and the eNodeB may cache this file. As illustrated, a second UE may request the same MPD file from the same remote server. Because the MPD file has been cached at the eNodeB, the request for the MPD file may be satisfied by the eNodeB transmitting the cached MPD file to the second UE, thus eliminating the additional time needed to request the MPD file from the remote server.

The first UE may, after reading the MPD file, request segments of a video file from the remote server. The remote server may respond with a requested segment of video, which the eNodeB may store in a cache. The second UE, after reading the MPD file, may also request segments of a video file from the remote server. Since these segments have already been cached at the eNodeB, the eNodeB, rather than the remote server, may provide the requested segments to the second UE.

As illustrated, an eNodeB may detect that many UEs are requesting the same content. In response, the eNodeB may enable broadcast or multicast service (e.g., eMBMS or SC-PTM) for traffic offload, and UEs requesting content may be redirected to the broadcast or multicast service to receive the content.

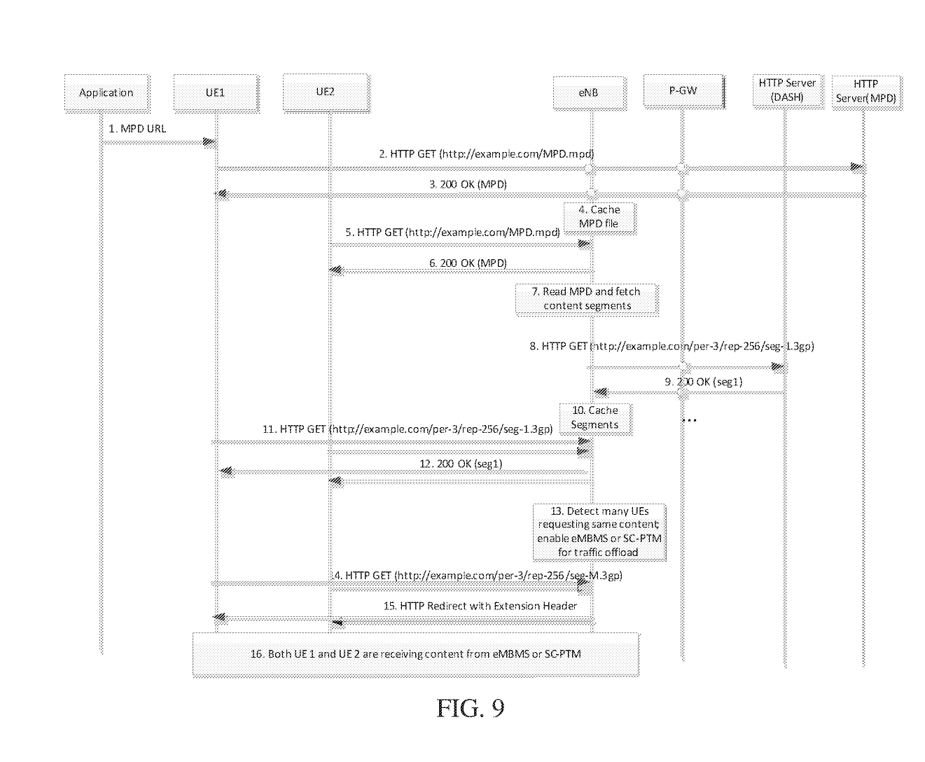

FIG. 9 illustrates an example of content caching at an eNodeB, according to an aspect of the present disclosure. Similarly to the example illustrated in FIG. 8, the first UE may request content (e.g., an MPD file) from a remote server. The eNodeB may cache the MPD file for provisioning to other UEs that request the same content (e.g., the second UE illustrated in this example). The eNodeB may also act as a client device requesting the content described in the MPD file from the remote server. This content (e.g., segments of a video file) may also be cached at the eNodeB.

As illustrated, both the first and second UEs may request a segment of a video file described by the MPD file. Since the eNodeB has already retrieved the requested segment from the remote server and cached the segment, the eNodeB, rather than the remote server, may provide the requested segment to the first and second UEs. As with the example illustrated in FIG. 8, when an eNodeB detects that many UEs are requesting the same content, the eNodeB may enable broadcast or multicast service and redirect the UEs requesting the content to the broadcast or multicast service to receive the content.

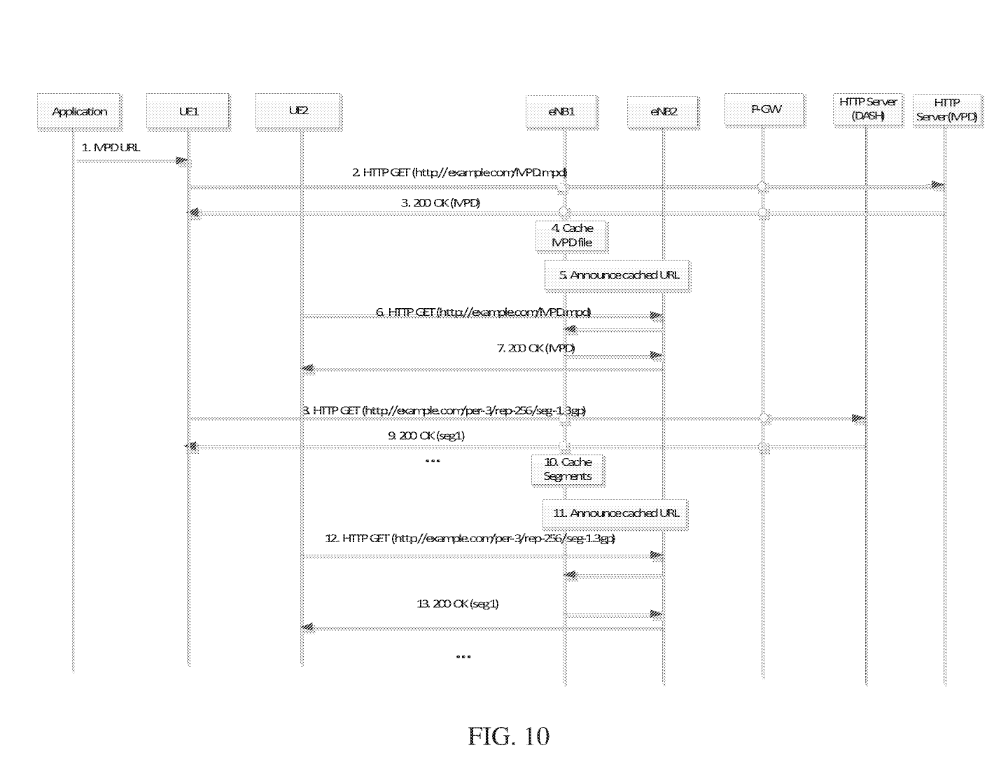

FIG. 10 illustrates an example of content caching at a plurality of eNodeBs, according to an aspect of the present disclosure. As illustrated herein, the first UE communicates with the first eNodeB, and the second UE communicates with the second eNodeB. Similarly to the examples illustrated in FIGS. 8 and 9, a first UE may request content (e.g., an MPD file) from a remote server. As illustrated, a first eNodeB may cache the MPD file for provisioning to other UEs that request the same content (e.g., the second UE illustrated in this example). The first eNodeB may further announce to neighboring eNodeBs (e.g., the second eNodeB illustrated in this example) that the first eNodeB has cached the content and an indication of the associated URL.

As illustrated, the second UE may request the same MPD file from a second eNodeB. Since the first eNodeB has announced that the MPD file has been previously requested and cached at the first eNodeB, the second eNodeB may retrieve the cached MPD file from the first eNodeB, and then transmit the MPD file to the second UE.

The first UE may request a segment of a video file described by the MPD file from the remote server. Similarly to the request of the MPD file, the eNodeB may cache the requested segment and announce to neighboring eNodeBs that the segment has been cached at the first eNodeB, along with the URL of the cached segment. When a second UE requests the segment, via the second eNodeB, the second eNodeB may retrieve the cached segment from the first eNodeB and transmit the segment to the second UE without requesting the segment from the remote server.

In aspects, the present disclosure provides methods and apparatus for wireless communications over a network by a base station configured to cache requested content and provide the cached content to requesting UEs. According to aspects, the processor 230, TX data processor 214, and/or other processors and modules at the transmitter system 210 may perform or direct processes for such methods.

It is understood that the specific order or hierarchy of steps in the processes disclosed is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Those of skill in the art would understand that information and signals may be represented using any of a variety of different technologies and techniques. For example, data, instructions, commands, information, signals, bits, symbols and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as hardware or software/firmware, or combinations thereof. To clearly illustrate this interchangeability of hardware and software/firmware, various illustrative components, blocks, modules, circuits, and steps have been described above generally in terms of their functionality. Whether such functionality is implemented as hardware or software/firmware depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software/firmware module executed by a processor, or in a combination of the two. A software/firmware module may reside in RAM memory, flash memory, ROM memory, EPROM memory, EEPROM memory, phase change memory (PCM), registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A method for wireless communications by a base station, comprising:
retrieving content from a remote server;
storing at least a portion of the content in a local cache at the base station;
receiving, from a first user equipment (UE), a request for the content; and
providing at least a portion of the content to the first UE from the local cache at the base station.

2. The method of claim 1, further comprising:
receiving a request for the content from a second UE, wherein the request from the second UE is received before the request from the first UE; and
based on the request from the second UE, retrieving the content from the remote server.

3. The method of claim 1, wherein the content comprises an identification of a requested file.

4. The method of claim 3, wherein storing the at least the portion of the content in the local cache comprises storing one or more segments of the requested file.

5. The method of claim 2, wherein the content comprises an identification of a requested file, further comprising:
beginning retrieval of one or more segments of the requested file from the remote source before receiving a request for the one or more segments by one of the first UE or at least the second UE.

6. The method of claim 2, further comprising:
determining that a number of UEs requesting the content exceeds a threshold; and
transmitting the stored content to the UEs via a multicast or broadcast channel.

7. The method of claim 2, further comprising:
determining that a number of UEs requesting the content exceeds a threshold; and
transmitting the content from the local cache to the UEs via a different Radio Access Technology (RAT).

8. The method of claim 1, further comprising:
storing the at least the portion of the content in the local cache at the base station or in a local cache located at a neighbor base station; and
coordinating transmission of the content with the neighbor base station.

9. The method of claim 8, wherein the coordinating transmission comprises:
pushing the at least the portion of the content to the neighbor base station.

10. The method of claim 8, wherein the coordinating transmission comprises:
announcing a file location associated with the at least the portion of the content to the neighbor base station;
receiving a request for the at least the portion of the content from the neighbor base station; and
transmitting the at least the portion of the content to the neighbor base station.

11. The method of claim 8, wherein the coordinating transmission comprises:
announcing a file location associated with the at least the portion of the content to a mobility management entity (MME); and
querying the MME to determine a base station at which content has been cached.

12. The method of claim 1, further comprising:
determining that the content has been requested by one or more UEs associated with a second base station; and
coordinating transmission of the content with the second base station.

13. The method of claim 12, wherein coordinating transmission of the content with the second base station comprises:
coordinating a multimedia broadcast/multicast services (MBMS) session with the second base station; and
directing the one or more UEs to tune to a channel on which the MBMS session is established.

14. The method of claim 13, further comprising:
transmitting, to the one or more UEs, MBMS user service description information.

15. The method of claim 14, wherein the MBMS user service description information is transmitted via at least one of dedicated signaling, a single cell point-to-multipoint (SC-PTM) channel, or an MBMS channel.

16. The method of claim 12, wherein the second base station is a neighbor base station.

17. An apparatus for wireless communications, comprising at least one processor configured to:
retrieve content from a remote server;
store at least a portion of the content in a local cache at the base station;
receive, from a first user equipment (UE), a request for the content; and
provide at least a portion of the content to the first UE from the local cache at the base station.

18. An apparatus for wireless communications, comprising:
means for retrieving content from a remote server;
means for storing at least a portion of the content in a local cache at the base station;
means for receiving, from a first user equipment (UE), a request for the content; and
means for providing at least a portion of the content to the first UE from the local cache at the base station.

19. A computer-readable medium for wireless communications, comprising:
code to retrieve content from a remote server;
code to store at least a portion of the content in a local cache at the base station;
code to receive, from a first user equipment (UE), a request for the content; and
code to provide at least a portion of the content to the first UE from the local cache at the base station.
